(19) United States
(12) Patent Application Publication
(10) Pub. No.: US 2023/0110133 A1
(43) Pub. Date: Apr. 13, 2023

(54) TOUCHPAD WITH FORCE SENSING COMPONENTS AND METHOD FOR ASSESSING HEALTH OF FORCE SENSING COMPONENTS IN-SITU

(71) Applicant: GOOGLE LLC, Mountain View, CA (US)

(72) Inventor: Nikesh Tayi Dhar, San Jose, CA (US)

(21) Appl. No.: 17/905,432

(22) PCT Filed: Mar. 20, 2020
(86) PCT No.: PCT/US2020/023909

§ 371 Date: Sep. 1, 2022

(51) Int. Cl. G06F 3/041

(52) U.S. Cl. CPC G06F 3/04142; G06F 3/0418; G06F 2203/04105

(57) ABSTRACT

A system and method for assessing the condition of components of a touchpad assembly may include in-situ monitoring of components of the touchpad assembly. A stress pattern including sequential application tensile stresses and shear stresses may be applied to the touchpad assembly during fabrication to induce early failure of compromised components, and isolate the compromised components before product release. The compromised components may be identified based on resistivity levels below a threshold resistivity level as a result of the stress pattern applied. In operation, resistivity levels may be collected and monitored, and degradation of components may be identified based on changes in the resistivity levels that are greater than a threshold difference. Calibration weights for inputs processed by the touchpad assembly may be adjusted, based on detected changes in resistivity levels during operation.

### TECHNICAL FIELD

This document relates, generally, to a trackpad, and in particular, to a trackpad having force sensing components.

### BACKGROUND

Some devices use a trackpad or touchpad to register input from a user to the system. Input can be registered as position information to guide the user in pointing to objects or locations on an accompanying screen. Input can be registered as a force or displacement, to allow the user to click on a displayed object. Such actuation can therefore be constrained to pressing primarily on a particular section of the pad. A system that can receive user inputs on a greater portion of the touchpad may enhance utility to the user, and may improve user satisfaction with the end product. A system that provides for assessment of the integrity of the force sensing components, and for early prediction of failure of force sensing components, may enhance utility to the user, and may improve user satisfaction with the end product.

### SUMMARY

In one aspect, a computer-implemented method for detecting a condition of a plurality of compliant members of a touchpad assembly installed in a computing device may include detecting, by a processor of the computing device, a current resistivity value of the touchpad assembly, comparing, by the processor, the current resistivity value to a set resistivity value, determining, by the processor, a difference between the current resistivity value and the set resistivity value, and re-setting, by the processor, at least one calibration weight associated with the touchpad assembly in response to a determination that the difference between the current resistivity value and the set resistivity value is greater than a threshold difference value.

Implementations may include any or all of the following features. For example, in some implementations, detecting the current resistivity value may include detecting the current resistivity value corresponding to a given input force at the touchpad assembly, and comparing the current resistivity value to the set resistivity value may include comparing the current resistivity value corresponding to the given input force to the set resistivity value corresponding to the given input force.

In some implementations, re-setting the at least one calibration weight may include re-setting a calibration weight associated with the touchpad assembly corresponding to the given input force. In some implementations, re-setting the at least one calibration weight may include receiving, by the processor from an external source, one or more updated calibration weights, and re-setting, by the processor, the one or more calibration weights based on the received updated calibration weights. In some implementations, the detecting, the comparing, and the determining by the processor may include iteratively detecting the current resistivity value, iteratively comparing the current resistivity value to the set resistivity value, and iteratively determining the difference between the current resistivity value and the set resistivity value.

In another general aspect, a computer-implemented method for detecting a condition of a plurality of compliant members of a touchpad assembly may include applying a plurality of stresses to the touchpad assembly, including applying a tensile stress to a touch input surface of the touchpad assembly, and sequentially applying a plurality of shear stresses to the touch input surface of the touchpad assembly, measuring a resistivity of the touchpad assembly, and detecting the condition of the plurality of compliant members based on the resistivity.

Implementations may include any or all of the following features. For example, in some implementations, measuring the resistivity of the touchpad assembly may include measuring the resistivity of the touchpad assembly concurrently with applying the plurality of stresses to the touchpad assembly. In some implementations, detecting the condition of the plurality of compliant members may include comparing the measured resistivity of the touchpad assembly to a threshold resistivity value, detecting that the measured resistivity is different from the threshold resistivity value, and detecting a fault in one or more of the plurality of compliant members in response to the detection of the measured resistivity that is different from the threshold resistivity.

In some implementations, detecting that the measured resistivity is different from the threshold resistivity value may include detecting that the measured resistivity is different from the threshold resistivity value by a set amount, and detecting the fault may include detecting the fault in one or more of the plurality of compliant members in response to the detection of the measured resistivity that is different from the threshold resistivity by the set amount. In some implementations, detecting that the measured resistivity is different from the threshold resistivity value by a set amount may include detecting that the measured resistivity is greater than the threshold resistivity value by the set amount. In some implementations, detecting that the measured resistivity is different from the threshold resistivity value by a set amount may include detecting that the measured resistivity is less than the threshold resistivity value by the set amount.

In some implementations, sequentially applying a plurality of shear stresses to the touch input surface of the touchpad assembly may include applying a first shear stress in a first direction with respect to the touch input surface of the touchpad assembly, applying a second shear stress in a second direction with respect to the touch input surface of the touchpad assembly, applying a third shear stress in a third direction with respect to the touch input surface of the touchpad assembly, and applying a fourth shear stress in a fourth direction with respect to the touch input surface of the touchpad assembly.

In some implementations, applying the first shear stress may include applying the first shear stress in the first direction, at a first portion of the touch input surface of the touchpad assembly so as to apply the first shear stress to a first subset of the plurality of compliant members, applying the second shear stress may include applying the second shear stress in the second direction, at a second portion of the touch input surface of the touchpad assembly so as to apply the second shear stress to a second subset of the plurality of compliant members, applying the third shear stress may include applying the third shear stress in the third direction, at a third portion of the touch input surface of the touchpad assembly so as to apply the third shear stress to a third subset of the plurality of compliant members, and applying the fourth shear stress may include applying the fourth shear stress in the fourth direction, at a fourth portion of the touch input surface of the touchpad assembly so as to apply the fourth shear stress to a fourth subset of the plurality of compliant members. In some implementations, the second direction may be opposite the first direction, and the third direction and the fourth direction may be substantially orthogonal to the first direction and the second direction. In some implementations, the first portion of the touch input surface may be a first corner portion of the touch input surface, the second portion of the touch input surface may be a second corner portion of the touch input surface, the third portion of the touch input surface may be a third corner portion of the touch input surface, and the fourth portion of the touch input surface may be a fourth corner portion of the touch input surface.

In another general aspect, a system may include a touchpad assembly, and a processor operably coupled to the touchpad assembly. The processor may be configured to execute a method. The method may include detecting a current resistivity value of the touchpad assembly corresponding to a given input force, comparing the current resistivity value to a set resistivity value at the given input force, determining a difference between the current resistivity value and the set resistivity value, and re-setting at least one calibration weight associated with the touchpad assembly in response to a determination that the difference between the current resistivity value and the set resistivity value is greater than a threshold difference value. In some implementations, re-setting the at least one calibration weight may include receiving one or more updated calibration weights from an external source, and re-setting the one or more calibration weights based on the received updated calibration weights.

### BRIEF DESCRIPTION OF DRAWINGS

FIGS. 1A and 1B are perspective views of an exemplary computing device.

FIG. 2 is an exploded perspective view of an exemplary touchpad assembly, for use in an exemplary computing device, in accordance with implementations described herein.

FIG. 3 is a partially exploded perspective view of the exemplary touchpad assembly shown in FIG. 2, in accordance with implementations described herein.

FIG. 4 is a partially exploded view illustrating the exemplary touchpad assembly, an exemplary substrate, and an exemplary target plate , in accordance with implementations described herein.

FIG. 5 is a partially exploded view illustrating the exemplary touchpad assembly, exemplary springs, and exemplary compliant members, in accordance with implementations described herein.

FIG. 6 is an assembled planar view of the exemplary touchpad assembly in a housing of the exemplary computing device, in accordance with implementations described herein.

FIG. 7 is a schematic, partial cross-sectional view, taken along line A-A of FIG. 1A.

FIGS. 8A and 8B are partial cross-sectional views, taken along line A-A of FIG. 1A.

FIGS. 9A-9F are schematic diagrams of an exemplary stress pattern to be applied to an exemplary touchpad assembly, in accordance with implementations described herein.

FIG. 10 is a flowchart of an exemplary method of detecting a fault in an exemplary touchpad assembly, in accordance with implementations described herein.

FIG. 11 is an exemplary graph of changes in resistivity over time, in accordance with implementations described herein.

FIG. 12 is a flowchart of an exemplary method, in accordance with implementations described herein.

FIG. 13 is a block diagram of an exemplary computing system that provide force and touch sensing.

FIG. 14 is a plan view of an exemplary inductive element.

FIGS. 15A and 15B are block diagrams of exemplary force sensing circuitry.

FIG. 16 illustrates an exemplary computing device and an exemplary mobile computing device that can be used to implement the techniques described here.

Like reference symbols in the various drawings indicate like elements. In some implementations, force detection (e.g., to recognize that a user “clicks” using a finger or stylus) can be performed based on inductive detection. For example, a spring can facilitate the movement of at least part of a trackpad assembly as a result of the applied force. In some implementations, haptic output is provided by an actuator mounted to a circuit board. In some implementations, grounding of a circuit board in a trackpad assembly is provided.

### DETAILED DESCRIPTION

This document describes examples of input devices, such as trackpads or touchpads, having internal components whose integrity may be assessed, to maintain functionality of the trackpad, or touchpad, thus prolonging functional life of the trackpad, or touchpad, and maintaining user satisfaction with the end product. In particular, this document describes exemplary systems and methods for assessing and monitoring the integrity of compliant, or elastic, components of trackpads, or touchpads, so as to maintain proper operation of the trackpads, or touchpads, and prolong functional life thereof

A trackpad or touchpad are mentioned herein as examples, and may be considered synonymous. Either or both of these types of input devices may include a surface defined by a substrate, such as, for example, glass, metal and/or a synthetic material such as a polymer, intended to be touched by a touching implement operated by the user in order to make one or more inputs into a system. In some implementations, the surface may be intended to receive a force, allowing the user to make one or more inputs into the system, separate from, or combined with, the touch input. In making touch inputs, the user can place one or more fingers, a stylus, and/or one or more other objects on the touch surface of the substrate to generate touch/drag inputs, gestures, sequences, patterns, force selection inputs, and other such inputs.

In some implementations, position detection can be performed using capacitive sensing to detect a position of the touching implement on the touch surface of the touchpad. For example, the detection of a fingertip and/or a capacitive stylus at or near the touch surface of the substrate can change the electrical capacitance of a corresponding portion of the substrate, and therefore be registered as an input. As such, while examples herein mention the user touching a substrate in order to make input, it may be sufficient to place an object sufficiently close to, without actually touching, the substrate. In some implementations, resistive sensing may be used for position sensing, by altering the resistance of electrodes in or on the substrate, thereby facilitating recognition of the input. In some implementations, force detection, for example, to recognize or detect a click, using a finger or stylus, can be performed based on inductive sensing. For example, in some implementations, a spring can facilitate the movement of at least part of a touchpad assembly as a result of the applied force.

In some implementations, an input device such as a touchpad can be used simply to receive user input. In some implementations, an input device such as a trackpad can be used simultaneously or at other times perform one or more other functions in addition to receiving input. In some implementations, the touchpad can provide haptic output to the user. In some implementations, the touchpad can include a display device configured to output visual information to the user.

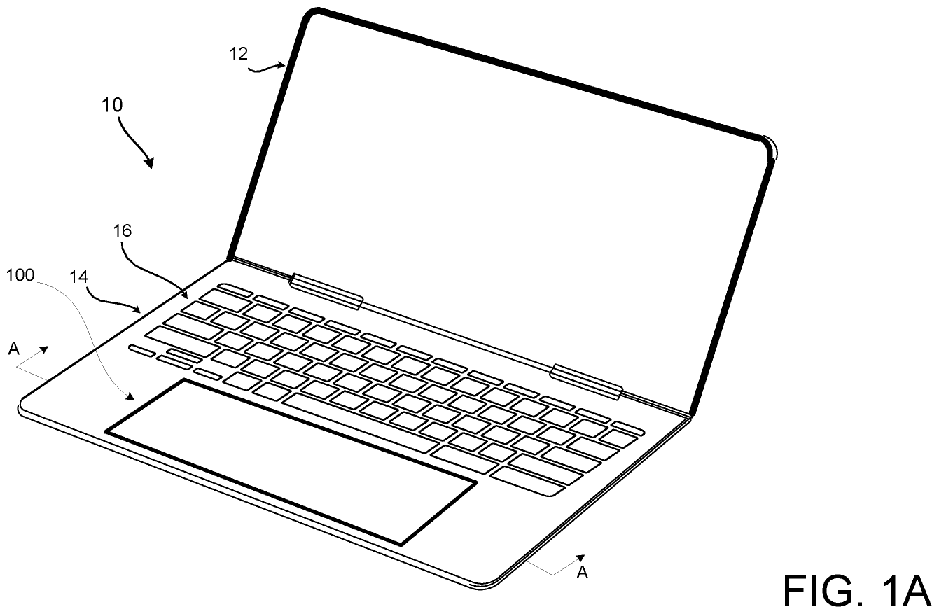

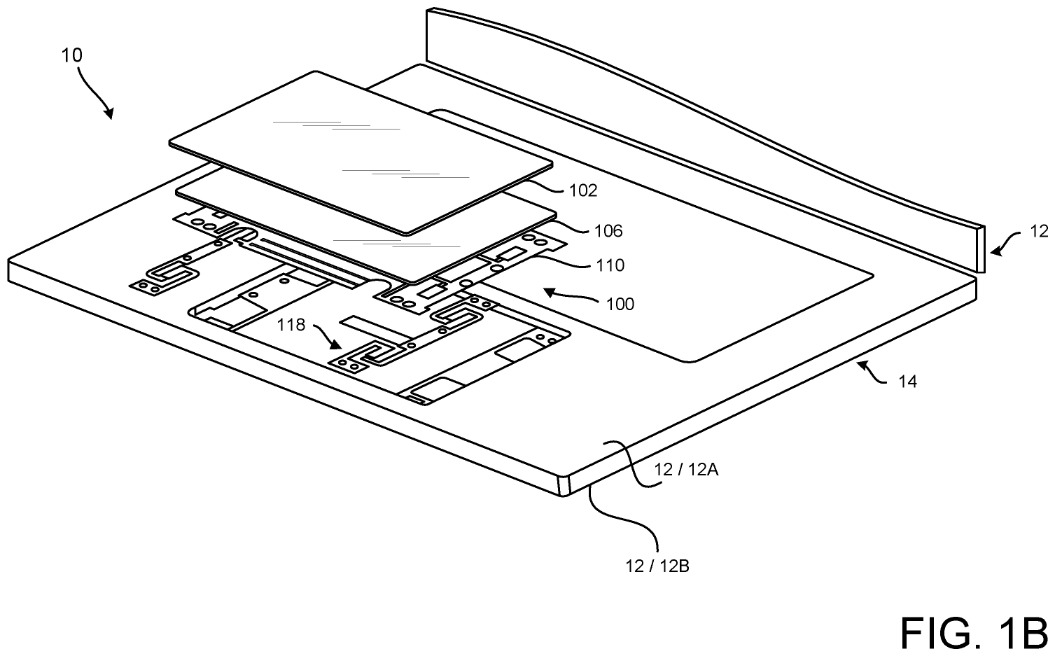

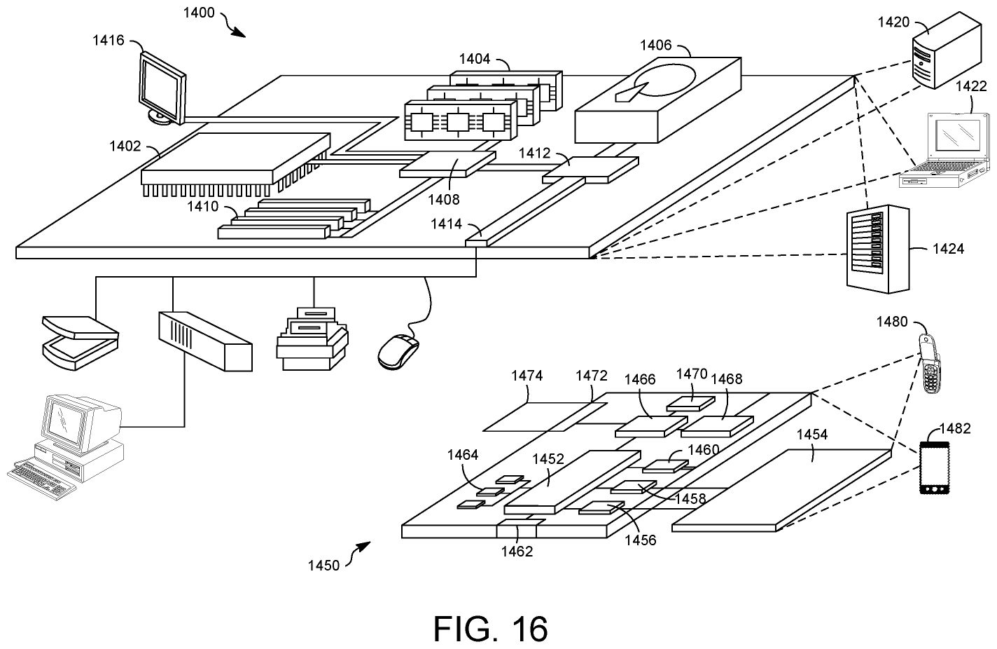

An exemplary computing device 10 is shown in FIGS. 1A and 1B. The exemplary computing device 10 includes a display portion 12 rotatably coupled to a base portion 14, the base portion 14 including a housing 12 having a top surface portion 12A and a bottom surface portion 12B. In this exemplary computing device 10, input devices including, for example, a keyboard 16 and a touchpad assembly 100, may be installed in the base portion 14. The exemplary computing device 10 shown in FIG. 1 is in the form of an exemplary laptop computing device 10 which may include a touchpad assembly, in accordance with implementations described herein, simply for ease of discussion and illustration. However, the exemplary touchpad assemblyl00 (shown in an assembled manner in FIG. 1A, and in a partially exploded manner in FIG. 1B) may be included in a variety of different types of computing devices. A touchpad assembly, in accordance with implementations described herein, may be incorporated into other types of computing devices. For example, a touchpad, in accordance with implementations described herein, can be implemented in one or more devices exemplified below with reference to FIG. 16.

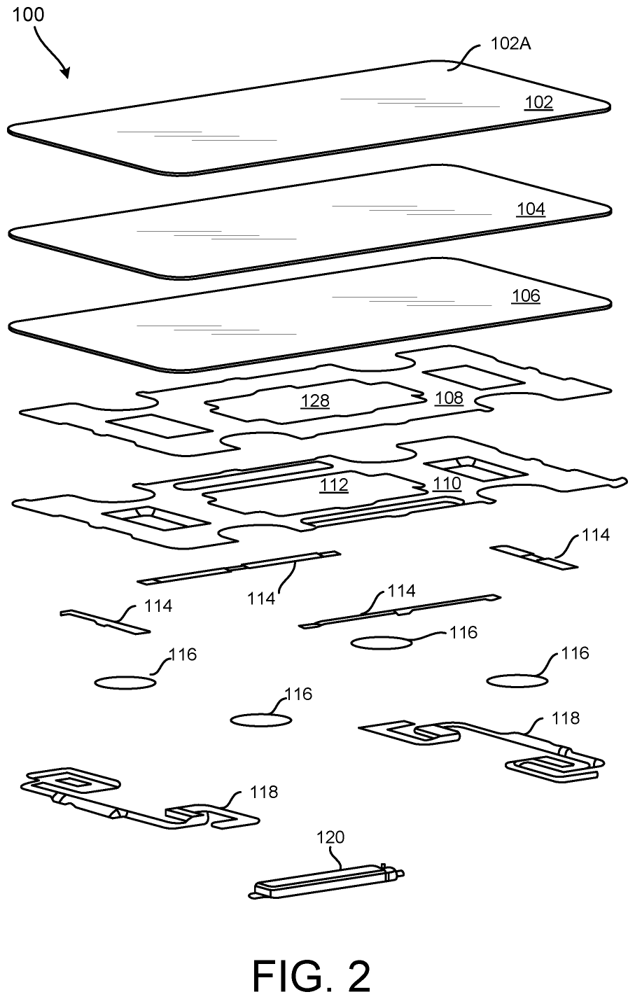

FIG. 2 is an exploded perspective view of the exemplary touchpad assembly 100 shown in FIGS. 1A and 1B. The exemplary touchpad assembly 100 may include a substrate 102 with a surface 102A that can be installed in a computing device so as to be accessible to a user for input. In some implementations, the substrate 102 can include a glass material, a polymer material and the like. In some implementations, a layer 104 may be applied to some or all of a surface 102B of the substrate 102 that is opposite the surface 102A. In some implementations, the layer 104 can include a pressure-sensitive adhesive, a heat-activated film, and the like, to couple the substrate 102 and a circuit board 106.

In some implementations, the circuit board 106 may include electrical or electronic components, and connections therebetween, for sensing the contact or the proximate presence of an object such as the user's finger(s) and/or a stylus, and to generate a corresponding position signal. For example, capacitive and/or resistive sensing can be used for position sensing. The position signal can cause one or more actions to be performed, and/or one or more actions to be inhibited, in the system.

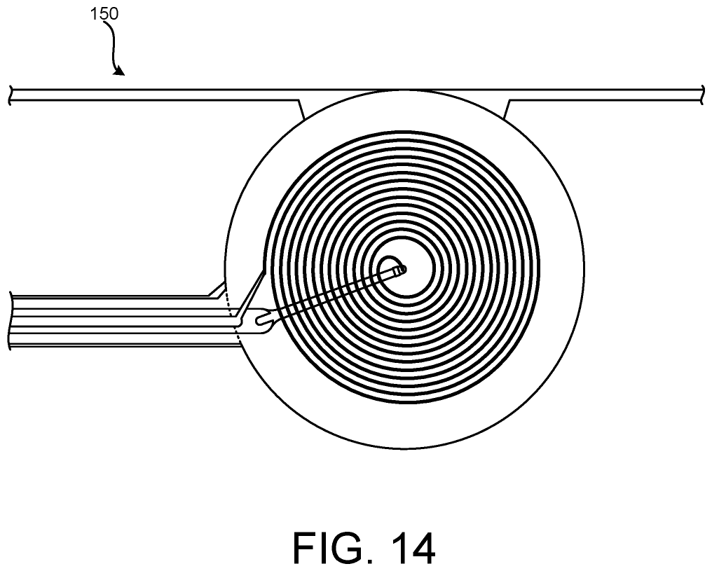

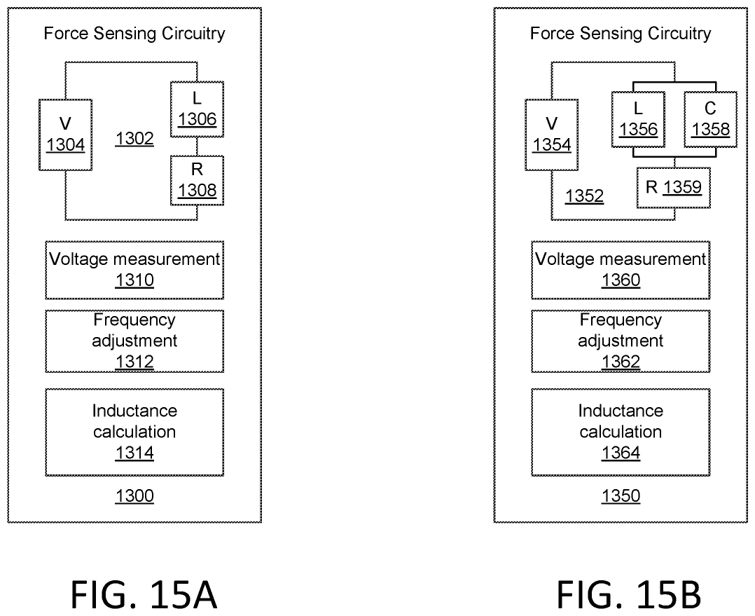

In some implementations, the circuit board 106 may include electrical or electronic components, and connections therebetween (such as, for example, exemplary force sensing circuitry as shown in FIGS. 15A and 15B, for sensing the force applied by the contact of an object such as the user's finger(s) and/or a stylus with the substrate 102, and to generate a corresponding force signal. The force sensing can be based on inductive measurement, for example, by way of one or more inductive elements positioned on or within the circuit board 106 (such as, for example, the exemplary inductive element 150 shown in FIG. 14) . For example, a change in inductance as a result of displacement of at least the circuit board 106 relative to another component of the system (e.g., a target plate or a housing of a device implementing the system) may be determined. The generated force signal(s) can cause one or more actions to be performed, and/or one or more actions to be inhibited, in the system. For example, and without limitation, the force signal can be recognized by the system as a click or tap, and the appropriate action(s) can be taken in response.

In some implementations, the touchpad 100 may include a layer 108 that is at least in part adhesive. In some implementations, the layer 108 can include a pressure-sensitive adhesive, a heat-activated film, and the like, to at least in part couple the circuit board to a stiffener plate 110.

The stiffener plate 110 may provide structural integrity to the circuit board 106 and/or to the substrate 102. For example, stiffness provided by the plate 110 can counteract forces applied due to a user touching or pressing on the substrate 102. As such, in an implementation of the touchpad 100 that includes the stiffener plate 110, the circuit board 106 and/or the substrate 102 need not be made as stiff as they otherwise might have been. In some implementations, the stiffener plate 110 can be made of metal material such as, for example, steel (for example, stainless steel), aluminum (for example, an aluminum alloy), and other such metal materials. In some implementations, the stiffener plate 110 can be stamped from material stock (e.g., a sheet of metal). The stiffener plate 110 can have one or more openings. For example, an opening 112 in the stiffener plate 110 can accommodate a haptic feedback component (e.g., as mounted to the circuit board 106).

In some implementations, the touchpad assembly 100 can include one or more grounding elements 114 that electrically connect the stiffener plate 110 and the circuit board 106. For example, the grounding elements 114 can be positioned between the stiffener plate 110 and the circuit board 106 so as to make electrical contact with the stiffener plate 110 and the circuit board 106 (e.g., with a ground contact provided on the circuit board 106). The exemplary grounding elements 114 can protect the circuit board 106 and components thereof against electrostatic discharge (ESD). For example, the grounding element(s) can lead charges from the circuit board 106 to a housing (of the computing device) to facilitate dissipation of high-voltage ESD.

In some implementations, the touchpad assembly 100 can include one or more pads 116 located at positions corresponding inductive element(s) on the circuit board 106. The exemplary pad(s) 116 shown in FIG. 2 are substantially disk-shaped. However, the pad(s) 116 can have any suitable shape. In some implementations, the pad(s) 116 can be made of materials that exhibit insulating qualities, to isolate components of the circuit board 106 from other components of the touchpad assembly 100. In some implementations, the pad(s) 116 can be made of a material having elastic qualities, thus deforming in response to forces applied (for example by a touch on the substrate 102), such as, for example, a viscoelastic material such as, for example, a silicone material, a foam material, a plastic material and the like.

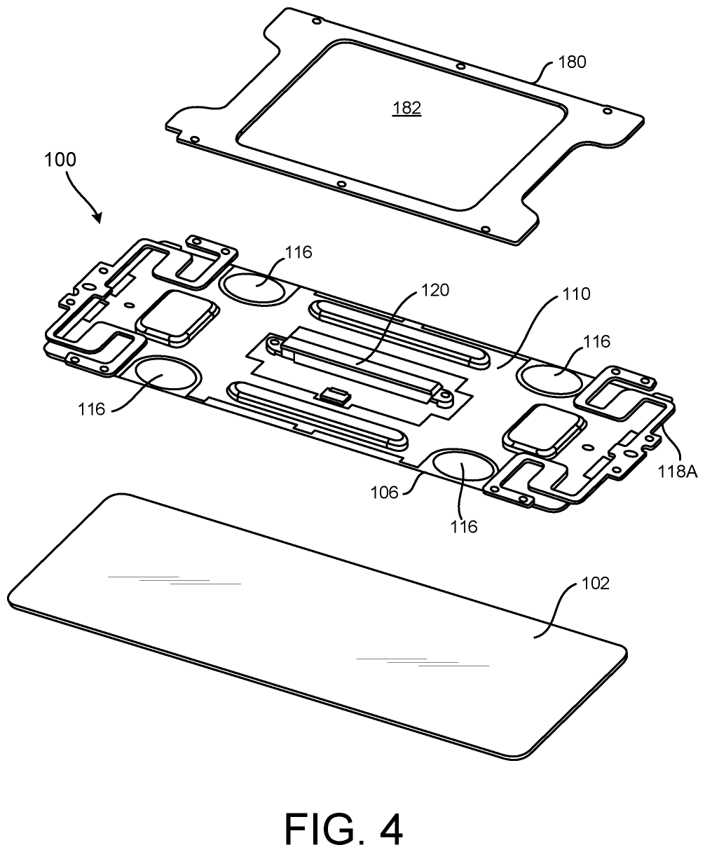

In some implementations, the touchpad assembly 100 can include one or more biasing members, or springs 118 configured for placement between the stiffener plate 110 and the housing 12 of the computing device. The spring(s) 118 can facilitate a change in distance, for example, between the stiffener plate 110/circuit board 106 and the housing 12/target plate 180 (see FIG. 4) based on a force applied to the substrate 102. The change in distance can cause a change in inductance that, when sensed, can be used to detect the applied force. The spring(s) 118 can be made of material having suitable stiffness such as, for example, a metal material such as, for example, stainless steel, or other such metal material. In some implementations, the springs 118 may be substantially identical to each other, and may be symmetrically arranged. Thus, in some implementations, the spring(s) 118 may provide both a suspension system for the touchpad 100, and may serve for integration of the touchpad into the overall system (e.g., the laptop computing device 10 shown in FIGS. 1A-1B, or other computing device).

In some implementations, the touchpad assembly 100 can include an actuator 120 configured to provide haptic output to the user via the substrate 102. In some implementations, the actuator 120 may be coupled to the circuit board 106, for example, mounted on a surface of the circuit board 106 opposite the surface thereof that faces the substrate 102. The opening 112 in the plate 110, and an opening 128 in the layer 108, may facilitate placement of the actuator 120 on the circuit board 106.

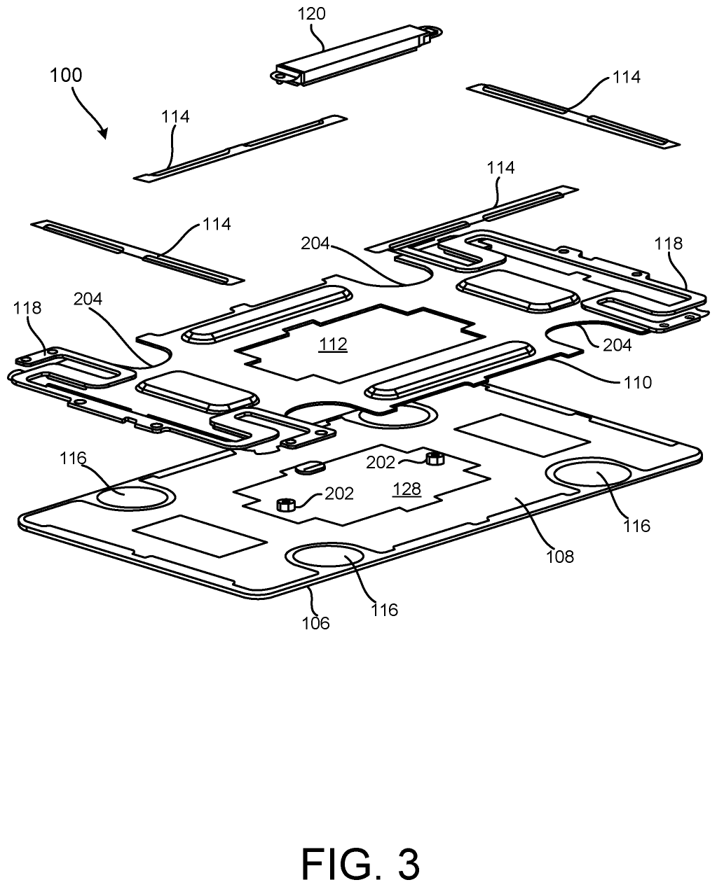

FIG. 3 is a partially exploded perspective view of an exemplary touchpad assemblyl00, shown from a different perspective than the perspective discussed above with respect to FIG. 2 (for example, a bottom perspective). In the view shown in FIG. 3, the layer 108 is positioned adjacent (e.g., abutting) the circuit board 106, with two of the springs 118 positioned at respective ends of the stiffener plate 110.

As noted above, the opening 128 in the layer 108 may define a space for placement of the actuator 120 on the circuit board 106, and the opening 112 in the stiffener plate 110 can facilitate the placement of the actuator 120. In some implementations, fasteners 202, such as, for example, self-clinching nuts 202 may facilitate attachment of the actuator 120 to the circuit board 106. The stiffener plate 110 can include openings and/or cutouts that facilitate force sensing (e.g., by inductive measurement). Features 204, or cutouts 204, defined in the stiffener plate 110 may expose inductive elements of the circuit board 106 (e.g., positioned adjacent to, and covered by, the pads 116 in the exemplary arrangement shown in FIG. 3), so that inductance can be measured.

FIG. 4 is a partially exploded perspective view of the exemplary touchpad assembly 100 including the target plate 180. In some implementations, a change in inductance caused by dislocation of the assembled circuit board 106/stiffener plate 110/actuator 120 and the substrate 102 as the user presses on the substrate 102, can be interpreted as a force and accordingly trigger a force signal in the system. As such, the touchpad assembly 100 can include an inductive force sensor that can detect inputs such as the user clicking, or pressing, on the substrate 102.

In some implementations, the target plate 180 can be made of a metal material such as, for example, a steel material, including, for example, stainless steel, aluminum (e.g., an alloy), magnesium alloy, a composite material, and other such materials. In some implementations, the target plate 180 can be secured to a housing of an electronic device (e.g., a housing of the exemplary computing device 10 shown in FIGS. 1A-1B, or other computing device). In contrast, an implementation can omit the target plate 180, wherein a portion of the housing (e.g., a metal body that at least partially encloses the system or device, including, but not limited to, a unibody housing) can instead serve the function of being used in inductive force sensing (as in the implementation described above with respect to FIGS. 2 and 3). In some implementations, an opening 182 can reduce an amount of material used in the target plate 180, and/or can accommodate one or more components.

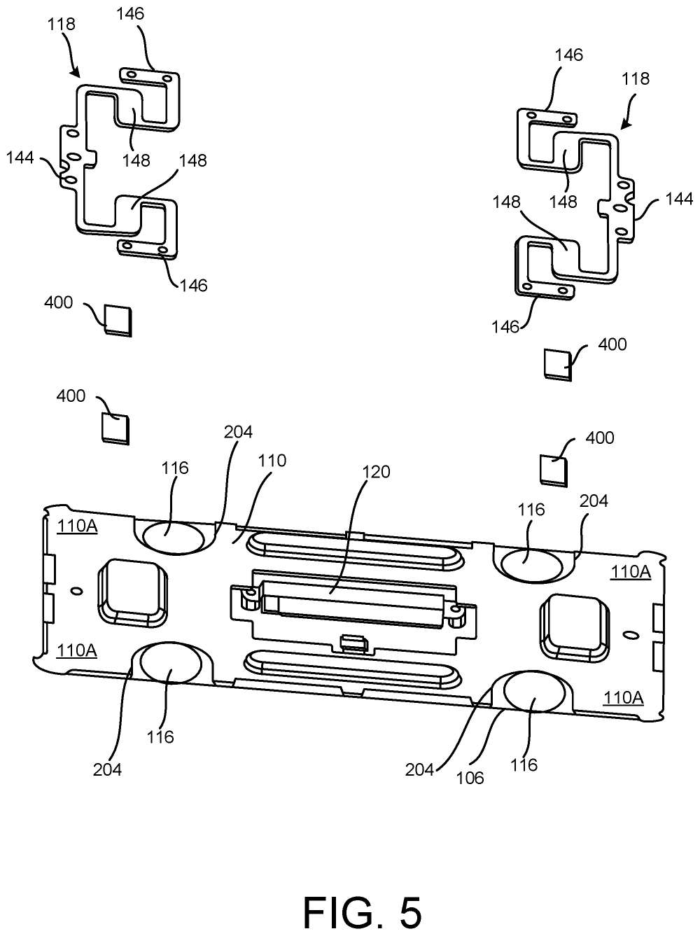

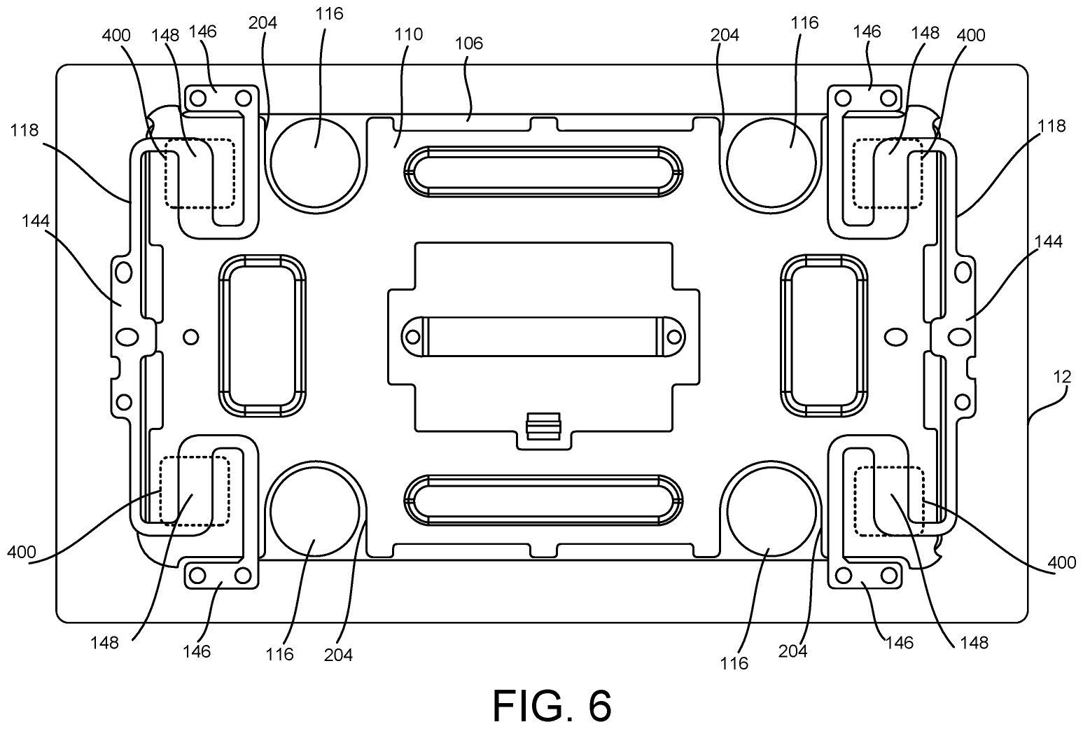

FIG. 5 is a partially exploded view, and FIG. 6 is an assembled planar view, of the exemplary touchpad assembly 100. In the partially exploded view shown in FIG. 5, or more compliant members 400 may be provided as an interface between the springs 118 and the stiffener plate 110. In some implementations, the compliant members 400 may be made of a foam material, and can be positioned, for example, between a corresponding portion 110A of the stiffener plate 110 and a bias portion 148 of the spring 118. That is, in this arrangement, the bias portion 148 is the only portion of the spring 118 that comes into contact with the compliant member 400, and essentially no portion of the spring 118 directly contacts the stiffener plate 110. In some implementations, the compliant member(s) 400 may provide x-dimension compliance for the touchpad assembly 100. The spring 118 may have fastening portions 144 and 146 that may be configured for attachment of the spring 118 to, for example, the target plate 180 or to the housing 12.

The compliant members 400 may be made from one or more suitable materials, such as, for example, a viscoelastic material, such as, for example, a high viscoelastic material such as, for example, a silicone material, a foam material, a polyurethane material, and the like. The material of the compliant members 400 may exhibit both viscous characteristics and elastic characteristics when undergoing deformation. This may allow the compliant members 400 to deform in response to both shear stresses and linear stresses (for example, in response to touch, drag and press inputs applied to the substrate 102).

Consistent, proper functionality of the touchpad assembly 100 is dependent at least in part on the integrity, for example, the structural integrity, of the compliant members 400. That is, the compliant members 400 (and the structural integrity thereof) are, at least in part, responsible for maintaining an inductive air gap, and in particular, an inductive air gap within the touchpad assembly 100 that is consistent with an external force applied. A system and method, in accordance with implementations described herein, may provide for detection of various types of degradation, or wear, or faults, in the compliant members 400, such as, for example, fatigue, cracking, material breakdown and the like, which would result in degraded performance of the touchpad assembly 100. In some implementations, the system and method may provide for detection of this type of faults, or wear, or degradation of the compliant members in-situ.

For example, in some implementations, the system and method may provide for detection of this type of degradation, or wear, or faults in the compliant members 400 during the fabrication process. This may allow compliant members 400 containing material imperfections, defects, deficiencies and the like to be identified and not released in a new product, thus avoiding premature malfunction or failure of a touchpad assembly in a relatively new product. In some implementations, the system and method may provide for detection of this type of degradation, or wear, or faults over the life of the computing device in which the touchpad assembly is installed. Detection of the degradation, or wear, or faults of the compliant members 400 during operation may provide for alteration of calibration weights, for example, during routine updating, so that the degradation, or wear, or faults remain essentially unnoticeable to the user during operation of the computing device.

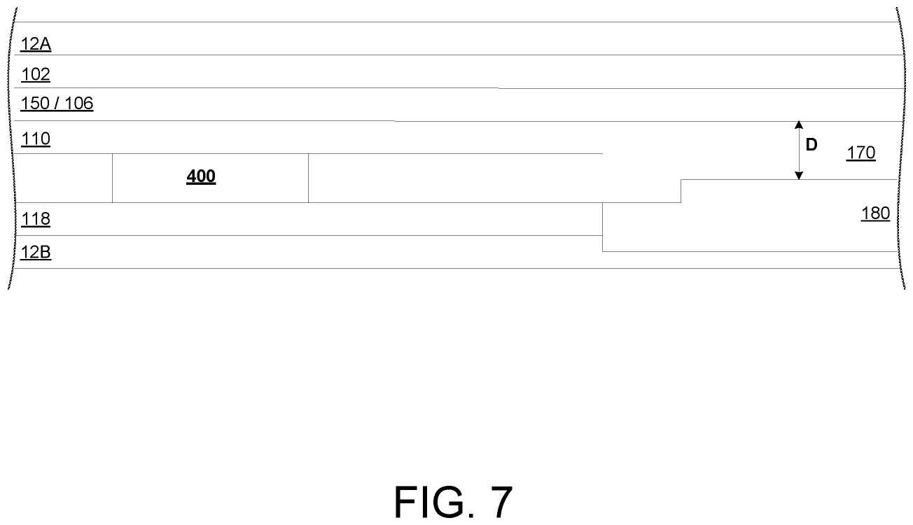

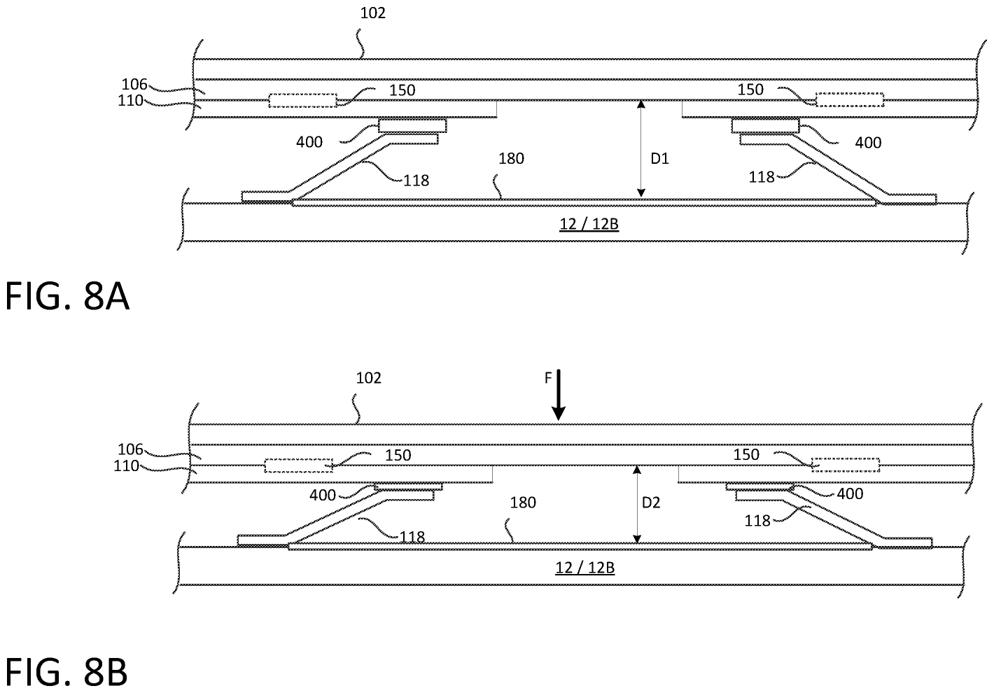

The inductance air gap will be described with respect to FIGS. 7-8B. FIG. 7 is a schematic cross-sectional view of components of the exemplary touchpad assembly installed in the exemplary computing device 10. FIGS. 8A and 8B are cross-sectional views , taken along line A-A of FIG. 1A.

As shown in FIG. 7, in some implementations, an inductive element 150, such as, for example, one or more sensing coils 150, may be connected to a force sensing circuit of the circuit board 106, to provide an inductive sensing mechanism for force detection. In operation, the inductive element 150 may generate an alternating current (AC) field to induce eddy currents in or on the target plate 180, such that the resulting magnetic field opposes the magnetic field of the inductive element 150. In some implementations, the level of inductance can depend on a distance D between the inductive element 150 and the target plate 180 representing a nominal gap 170 (i.e., an air gap 170) that has a predetermined length (e.g., within a certain tolerance) at the time of assembly or calibration. As such, when the distance D changes, such as, for example, due to a force applied to the touchpad, the force sensing circuit can sense the force by way of detecting the change in inductance and corresponding change in the distance D. As shown in FIGS. 8A and 8B, in response to a force F applied, for example, to the substrate 102 of the touchpad assembly 100, the distance D through the air gap defined within the touchpad assembly 100 may be decreased from the distance D1 shown in FIG. 8A to the distance D2 shown in FIG. 8B. As explained above, this change in the distance D may be associated with a corresponding change in inductance.

As noted above, in a system and method, in accordance with implementations described herein, integrity of the compliant members 400 may be assessed, for example, during the fabrication process, so that compliant members 400 containing material imperfections, defects, deficiencies and the like are identified before being released to consumers d in a new product, thus avoiding premature malfunction or failure of a touchpad assembly in a relatively new product. For example, a stress pattern, in accordance with implementations described herein, may be applied to the compliant members 400 to initiate early failure in new, compromised, compliant members 400 (i.e., compliant members 400 having material imperfections), in order to isolate infant mortality during the manufacturing process. A stress pattern, in accordance with implementations described herein, may induce failure in compromised compliant members 400 relatively quickly, compared to for example, traditional mechanical testing such as, for example, x-ray and other such methods, which is often time consuming and destructive.

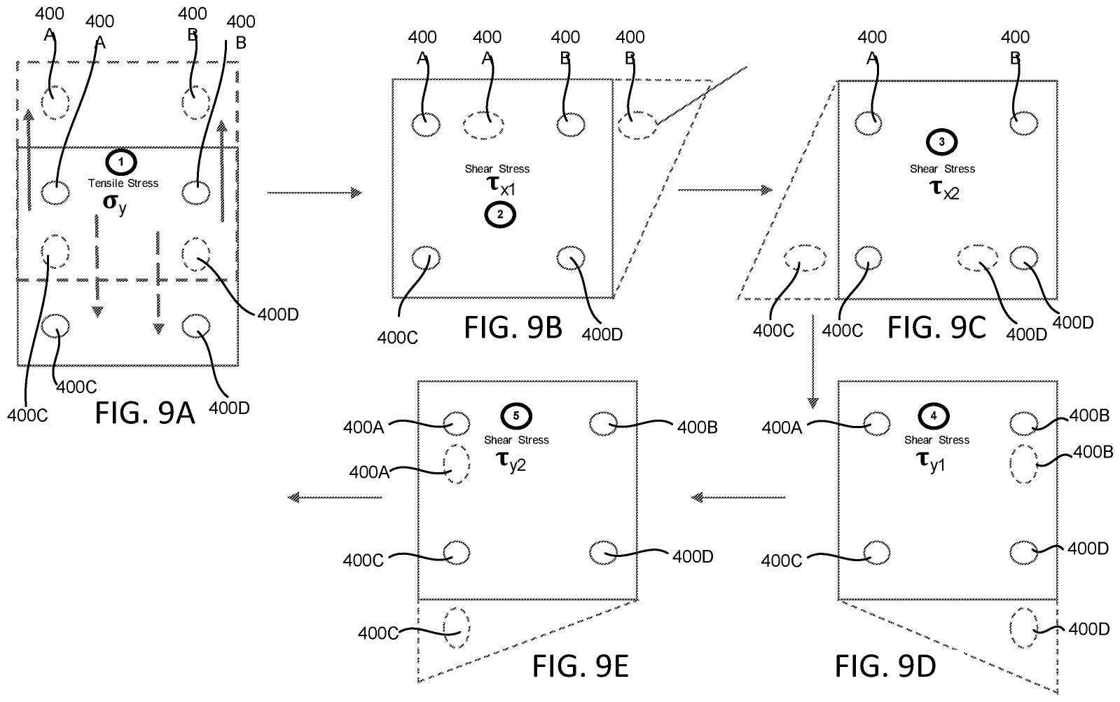

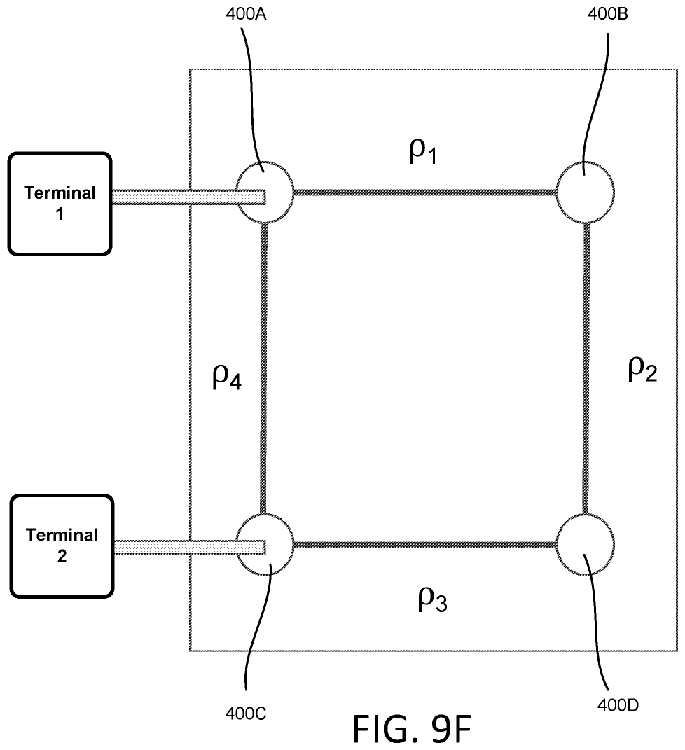

FIGS. 9A-9E schematically illustrates an exemplary stress pattern, in accordance with implementations described herein. The exemplary stress pattern shown in FIG. 9 may be applied, for example, to a touchpad assembly at an interim point in the fabrication process, to initiate and detect early failure of compromised compliant members 400 during fabrication, rather than after product release. As shown in FIG. 9, the exemplary stress pattern includes a sequential application of stresses 1 through 5, which, when applied sequentially, are shown to initiate early failure of already compromised compliant members 400.

Stress 1 includes an application of a stress σ_{Y} on the compliant members 400. The stress σ_{Y} is a tensile stress σ_{Y} on each of the four exemplary compliant members 400 (400A, 400B, 400C, 400D), in the Y direction, in particular, in the +Y direction and the −Y direction, in the orientation shown in FIG. 9A. Stress 2, applied following stress 1, includes a first shear stress τ_{X1}. The first shear stress τ_{X1} is a shear stress applied in the X direction (i.e., in a first direction, the +X direction in the orientation shown in FIG. 9B), at a portion of the touchpad assembly, for example, a corner portion of the touchpad assembly, that causes the first shear stress τ_{X1} to be applied to the compliant member 400A and the compliant member 400B, in the manner shown in FIG. 9B. Stress 3, applied following stress 2, includes a second shear stress τ_{X2}. The second shear stress τ_{X2} is a shear stress applied in the X direction (i.e., in a second direction opposite the first direction, the −X direction in the orientations shown in FIG. 9C), at a portion of the touchpad assembly, for example, a corner portion of the touchpad assembly, that causes the second shear stress τ_{X2} to be applied to the compliant member 400C and the compliant member 400D, in the manner shown in FIG. 9C. Stress 4, applied following stress 3, includes a third shear stress τ_{Y1}. The third shear stress τ_{Y1} is a shear stress applied in the Y direction, at a portion of the touchpad assembly, for example, a corner portion of the touchpad assembly, that causes the third shear stress τ_{Y1} to be applied to the compliant member 400B and the compliant member 400D, in the manner shown in FIG. 9D. Stress 5, applied following stress 4, includes a fourth shear stress τ_{Y2}. The fourth shear stress τ_{Y1} is a shear stress applied in the Y direction, at a portion of the touchpad assembly, for example, a corner portion of the touchpad assembly, that causes the shear stress to be applied to the compliant member 400A and the compliant member 400C, in the manner shown in FIG. 9E. The tensile stress and the plurality of shear stresses (i.e., stress 1 through stress 5 sequentially defining the stress pattern) may be sequentially applied as described above, for example, repeatedly sequentially applied as described above if necessary, to detect one or more already compromised compliant members 400 which could cause early malfunction of the touchpad assembly.

For example, in some implementations, a total resistivity ρₜₒₜₐₗ (i.e. where ρₜₒₜₐₗ is the sum of ρ₁+ρ₂+ρ₃+ρ₄) ma_{y} be measured, as shown in FIG. 9F, while the stress pattern shown in FIGS. 9A-9E is applied. A fluctuation in the total resistivity ρₜₒₜₐₗ, or a total resistivity ρₜₒₜₐₗ that is outside of a preset range, may provide an indication that one or more of the compliant members 400 is compromised. That is, a fluctuation in the total measured resistivity ρₜₒₜₐₗ, or a total measured resistivity ρₜₒₜₐₗ that is outside of a preset range, may provide an indication that one or more of the compliant members 400 may include, for example, a discontinuity or a crack, a material occlusion, or other such factor that degrades the performance of the complaint member(s) 400 and in turn will impede functionality of the touchpad. For example, in some implementations, the total measured resistivity ρₜₒₜₐₗ may be compared to a threshold value for resistivity, or a baseline value for resistivity. In some implementations, the comparison may indicate that that one or more of the compliant members 400 is compromised when the total measured resistivity ρₜₒₜₐₗ is greater than, or less than, the threshold resistivity value. In some implementations, the comparison may indicate that that one or more of the compliant members 400 is compromised when the total measured resistivity ρₜₒₜₐₗ is greater than, or less than, the threshold resistivity value by a set amount, or, for example, outside a +range of resistivity. In some implementations, the comparison may indicate that that one or more of the compliant members 400 is compromised when the total measured resistivity ρₜₒₜₐₗ is greater than, or less than, the threshold resistivity value by a set percentage.

In some implementations, application of the stress pattern, and the measurement of resistance through the compliant members 400 as the stress pattern is applied, as described above with respect to FIGS. 9A-9F, may be implemented in a test fixture in which one or more touch pad assemblies are received. In some implementations, the stress pattern may be applied to the one or more touchpad assemblies in a substantially automated fashion under the control of a computing device that is operably coupled to the test fixture. In some implementations, the resistance levels may be collected, for example, through the exemplary terminal T1 and T2 shown in FIG. 9F, and processed by the computing device. Thus, in some implementations, the application of the stress pattern and the collection of data as described above with respect to FIGS. 9A-9F may describe a computer-implemented method for detecting wear, or faults, or degradation in one or more compliant members 400 of a touchpad assembly, in accordance with implementations described herein.

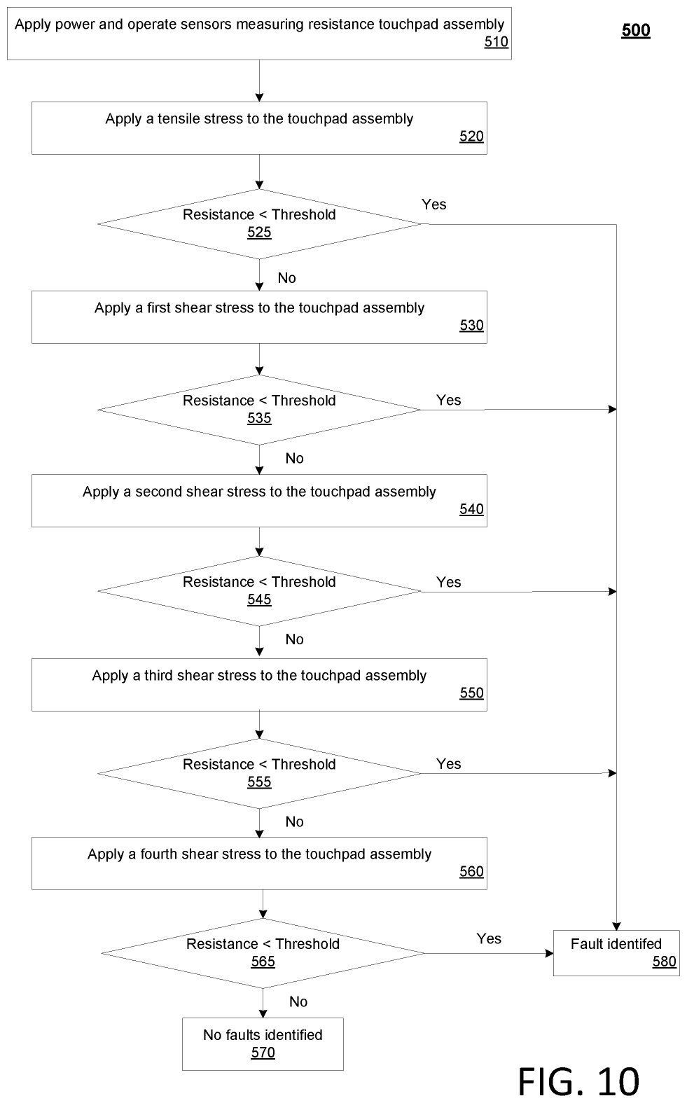

FIG. 10 is a flowchart of an exemplary method 500 of testing a touchpad assembly, in accordance with implementations described herein. As described above, the exemplary touchpad assembly (i.e., one or more touchpad assemblies) may be positioned in a text fixture, with power supplied to the touchpad assembly, and sensors measuring resistance through the touchpad assembly (block 510). The stress pattern, described in detail above with respect to FIGS. 9A-9E, may then be applied to the touchpad assembly, to isolate one or more compliant members 400 which may be, in some manner, mechanically compromised. That is, a tensile stress (i.e., the tensile stress σ_{Y} shown in FIG. 9A) may be applied (block 520). After application of the tensile stress, a first shear stress (i.e., the stress τ_{X1} shown in FIG. 9B), a second shear stress (i.e., the stress τ_{X2} shown in FIG. 9C), a third shear stress (i.e., the stress τ_{Y1} shown in FIG. 9D), and a fourth shear stress (i.e., the stress τ_{Y2} shown in FIG. 9E) may be sequentially applied (blocks 530, 540, 550 and 560, respectively). As the sensors are substantially continuously monitoring resistance through the touchpad assembly, if at any time it is detected that resistance is less than a threshold value (blocks 525, 535, 545, 555, 565) it may be determined that one or more of the compliant members 400 of the touchpad assembly is in a mechanically degraded condition, or a worn condition, or is faulty (block 580). If the measured resistance remains greater than or equal to the threshold value, it may be determined that the compliant members 400 of the touchpad assembly are mechanically intact, with no faults identified (block 570).

In some implementations, the stress pattern may be implemented as a burn-in procedure during the manufacturing/fabrication process. In some implementations, the pattern may be repeated multiple time. For example, in some implementations, the pattern can be repeated as many as 50 times. In some implementations, the pattern can be repeated fewer than 50 times. In some implementations, the pattern can be repeated as many as 50 times. In some implementations, the pattern can be repeated less than 50 times. In some implementations, a detected change in resistivity beyond a certain threshold may be implemented as pass-fail criteria as the pattern is applied. For example, in some implementations, a detected change in resistivity beyond, for example, approximately 10% may be indicative of a failure. In some implementations, the failure threshold may be greater than 10%. In some implementations, the failure threshold may be less than 10%.

In some situations, degradation, or wear, of one or more of the compliant members 400 may occur over time, during use of the touchpad assembly. For example, degradation, or wear, of one of more compliant members 400 of a touchpad assembly may occur over time, in regular use, even when the one or more compliant members 400 were not previously compromised in some manner as described above. This degradation, or wear, may, in some circumstances, effect functionality of the touchpad assembly. For example, in some situations, one or more of the compliant members 400 may develop a material crack or discontinuity, may suffer a breakdown of material, and the like, during regular use. In some situations, this degradation, or wear, may impact use of the touchpad assembly by a user. For example, as one or more of the compliant members 400 of a touchpad assembly degrades or wears (for example, develops a crack or other material discontinuity, develops an occlusion, experiences material breakdown or the like), the touchpad assembly may become less sensitive, or less responsive, to a user input, and in particular, to a force applied to an input surface of the touchpad assembly.

For example, in a new touchpad assembly, an amount of force applied to the new touchpad assembly may be associated with a corresponding change in inductance level, which, in turn, may be associated with a particular input and/or action to be taken (for example, a click). A calibration weights for each input force level may be stored in the new touchpad assembly, corresponding to inductance levels and inputs/actions respectively associated with the input force levels. Thus, as an input force (equated to a calibration weight) and associated change in induction level is detected on the touchpad assembly, the corresponding action, task or the like may be executed by the computing device in which the touchpad assembly is installed.

Degradation, or wear, over time, of the mechanical integrity of one or more of the compliant members 400 (for example, for one of the exemplary reasons described above), may cause the inductance associated with a particular input force to change, due to, for example, a corresponding change in the size of the air gap 170 discussed above with respect to FIGS. 7-8B (i.e., for the distance D to change). In the degraded or worn state, an input force originally associated with a particular command or action (per the stored calibration weight) may not necessarily achieve the associated inductance, depending on the degree of degradation or wear or failure in the compliant member 400, and in some situations, the associated command or action is not executed by the computing device. The degraded or worn or faulty condition of one or more of the compliant members may not necessarily render the touchpad non-functional. However, the degraded, or worn, or faulty condition of the one or more compliant members 400 may, over time, cause the user to find the touchpad assembly to be less sensitive, or less responsive. This may, in turn, cause the user to exert a greater input force on the touchpad assembly, or to push harder, thereby accelerating the degradation, or wear, of the one or more of the compliant members 400.

In some implementations, a system and method, in accordance with implementations described herein, may allow the condition of the compliant members 400 to be monitored in-situ, during the life of the computing device in which the touchpad assembly is installed. As described above, in operation, a change in the air gap 170 (see FIGS. 7-8B) due to an input force causes a change in induction, and a corresponding change in resistivity. Further, resistivity, as a material property, can be monitored, even in a zero force situation. That is, in a situation in which substantially no force is applied to the touchpad assembly, resistivity through the touchpad assembly may still be monitored, and a change detected which may be indicative of the condition of the compliant members 400. As described above, at initial operation of the touchpad assembly, for example, installed in a computing device, a given, initial input force will generate a given, initial change (i.e., a reduction) in the air gap 170, which corresponds to a given, initial change in inductance (and an associated resistivity) to register a user input command. After continued operation, the compliant members 400 may wear or degrade, to the point where the given, initial input force will no longer generate the given, initial change (i.e., reduction) in the air gap 170. Rather, in the worn or degraded condition, the given, initial input force generates a reduced change in the air gap 170, and a corresponding reduced change in inductance (and in the associated resistivity), or a change in sensitivity, for the same given input force. Thus, in the worn or degraded condition, a greater input force (than the initial, given input force) is applied to achieve the same change in the air gap 170 and corresponding change in inductance (and in the associated resistivity) to register the same user input command. Resistivity may be monitored in-situ, during operation, so that a detected change in resistivity that is less than expected for a given input force may provide an indication of a worn or degraded condition of one or more of the compliant members 400.

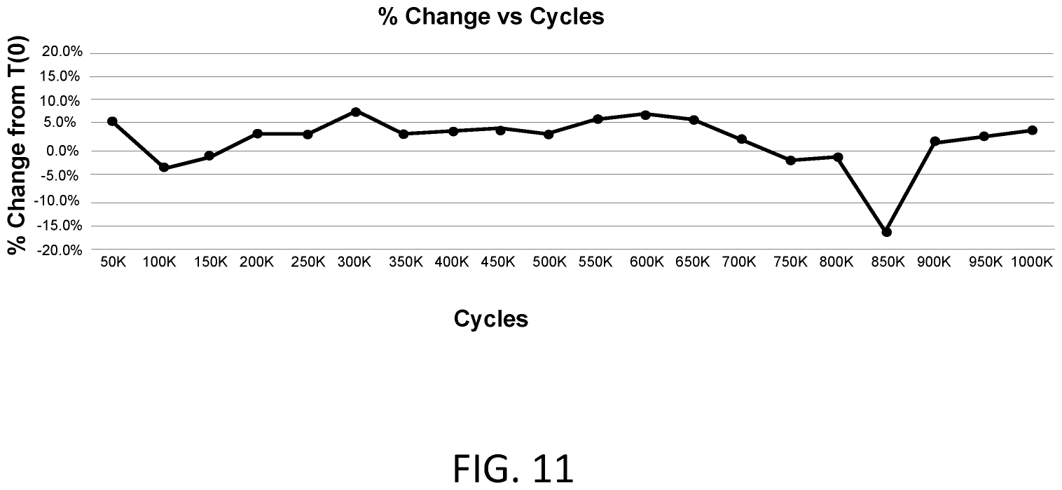

In some implementations, these in-situ measurements can be collected and analyzed to determine the relative condition of the compliant members 400 of a particular touchpad assembly. The graph shown in FIG. 11 illustrates exemplary data which may be collected over time to provide an indication of a worn or degraded condition of the compliant members 400, or an impending fault or failure of the compliant members 400. These exemplary graphs illustrate that, after some given number of cycles (for example, input forces applied to the respective touchpad assembly, for example, in the form of a click) after time T(0), there is a drop in resistivity of greater than a threshold value for the input force. For example, in some implementations, the threshold value may be in the form of a percentage drop. The point at which the measured resistivity is reduced by greater than or equal to the threshold value may represent a point at which degradation in the compliant members 400 may be present. Depending, for example, on a detected degree of change in resistivity for a given input force, the data collected via this in-situ monitoring may be used to adjust, or reset calibration weights.

In some implementations, this type of adjustment or reset of calibration weights may be substantially transparent to the user. For example, in some implementations, calibration weights may be adjusted during routine system software updates. In some implementations, data, such as, for example, the data shown in FIG. 11, may be collected and aggregated over time from a large number of users, to determine, for example, an average number of cycles, or an average amount of time in service, until wear or degradation is at the point at which decreases sensitivity and/or responsiveness may be noticeable to the user. An average number of cycles, or average time in service, may be used to push updated calibration weights out to users. In this manner, the application of updated calibration weights may be substantially transparent to users, and the user experience little to no degraded performance of the touchpad assembly installed in the computing device. In some implementations, this type of in-situ monitoring may be accomplished locally, for a specific touchpad assembly installed in a computing device. In some implementations, this data may be collected and monitored in-situ, without user intervention. In some implementations, upon detection of a decrease in resistivity exceeding the set threshold, or prediction of a detected decrease exceeding the set threshold within a relatively short period of time, the system may alert the user, and/or may prompt the user to allow for the reset of calibration weights as described above.

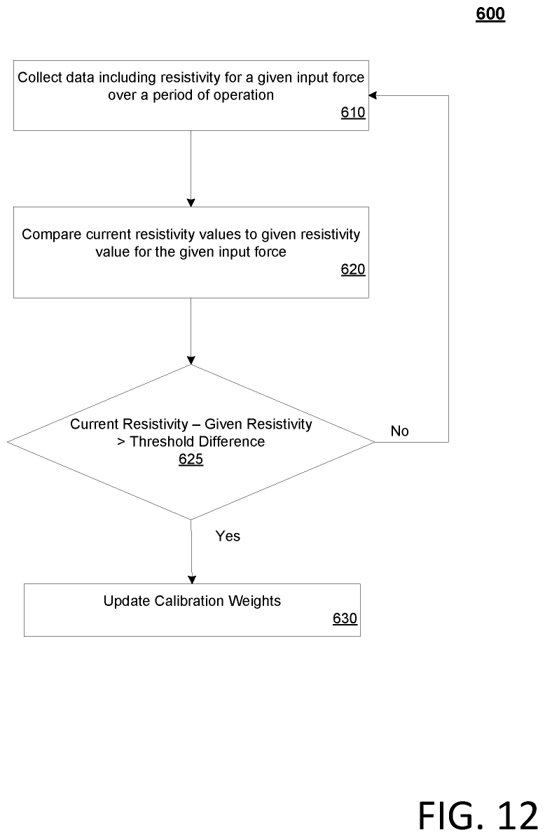

FIG. 12 is a flowchart of an exemplary method 600, in accordance with implementations described herein. As described above, data may be collected during operation of a computing device including a touchpad assembly (block 610). The data collected may include, for example, resistivity measurements for a given input force over time, each time the given force input is detected. As the data is substantially continuously collected, the current resistivity value may be compared to, for example, a given resistivity value associated with the given input force (block 620). When it is detected that a difference between a currently measured resistivity value and the given resistivity value (for the given input force) is greater than or equal to a threshold difference value (block 625), calibration weights may be updated, or reset (block 630), for example, in the manner described above.

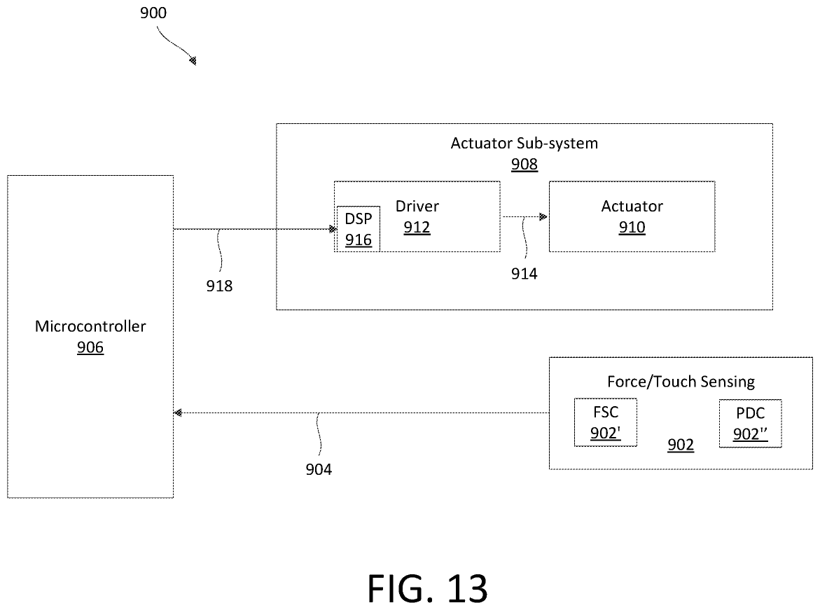

FIG. 13 is a block diagram of an exemplary computing system that may provide sensing of force and touch, and may provide haptic output. The exemplary computing system 900 may include a force/touch sensing component 902 that facilitates gesture inputs, force inputs and the like. The sensing of touch (e.g., by a capacitive and/or resistive array) can be separated (e.g., decoupled) from the sensing of force (e.g., by inductive measurement). In some implementations, the force/touch sensing component 902 can include circuitry configured for performing the sensing of force and/or touch. In this exemplary arrangement, the force/touch sensing component 902 includes force sensing circuitry 902′ including a voltage source and a resistor and/or a capacitor, and position detecting circuitry 902″ based on capacitive sensing. In some implementations, the position detecting circuitry 902″ can be based on resistive sensing. The force/touch sensing component 902 is coupled to one or more other aspects of the computing system 900, and input(s) to the force/touch sensing component 902 can trigger generating of at least one signal 904. The signal 904 may represent the gesture and/or force that was input using the force/touch sensing component 902.

The computing system 900 includes a microcontroller 906, including, for example, one or more processor cores, one or more memories, and one or more input/output components that allow the microcontroller 906 to communicate with other aspects of the computing system 900. In some implementations, the microcontroller 906 is implemented as part of a PCB/PCBA in an electronic device.

In some implementations, the microcontroller 906 senses the inductance relating to an inductive component on a circuit board and detects applied force accordingly. For example, a difference in inductance corresponding to a change in relative position between the inductive component and another component (e.g., a target plate or the housing, or another conductive component) can be detected. The microcontroller 906 can perform one or more actions in response to detection of force. One or more operations can be performed or inhibited, an output (e.g., visual and/or audio output) can be generated, information can be stored or erased, to name just a few examples.

The microcontroller 906 can perform functions regarding the control and provision of haptic output. An actuator sub-system 908, including an actuator 910 and a driver 912 coupled to the actuator 910, may be coupled to the microcontroller 906 and may be configured for providing haptic output. The actuator 910 may be coupled to a touchpad assembly to generate mechanical motion that is perceptible to a user. In some implementations, the actuator 910 is an electromagnetic actuator, such as, for example, a linear resonant actuator. The actuator 910 operates based on at least one touchpad driver signal 914 that the driver 912 provides to the actuator 910.

The operation of the driver 912 can be facilitated by at least one digital signal processor (DSP) 916. The DSP 916 for the driver 912 can be mounted on the driver 912. The DSP 916 can be coupled to the microcontroller 906, for example by a bus connection. The DSP 916 can instruct the driver 912 as to the touchpad driver signal 914 that is to be generated, and the driver 912 executes that instruction by controlling the operation of the actuator 910 in accordance with the trackpad driver signal 914. The driver 912 and/or the DSP 916 can receive at least one signal 918 from the microcontroller 906 and can operate based on, and in accordance with, the signal(s) 918.

An exemplary inductive element, such as the inductive element 150 referenced above, is illustrated in the plan view shown in FIG. 14. As noted above, in some implementations, the inductive element 150 may be implemented on the circuit board 106, for example, on the surface, or somewhat embedded into the surface of the circuit board 106.

FIGS. 15A and 15B are block diagrams of exemplary arrangements of exemplary force sensing circuitry. The exemplary force sensing circuitry shown in FIG. 15A may include a circuit 1302 having a voltage source 1304 (V), an inductance 1306 (L), and a resistance 1308 (R). The voltage source 1304, the inductance 1306, and the resistance 1308 may be electrically connected to each other in series as indicated to complete the circuit 1302. The inductance 1306 is the inductance that is the subject of the force sensing. The resistance 1308 may be a known resistance. In operation, the voltage source 1304 may provide voltage to the circuit 1302 in form of AC. A voltage measurement component 1310 (e.g., one or more chips or other integrated circuit (IC) components), may measure voltage at the junction between the inductance 1306 and the resistance 1308. A frequency adjustment component 1312 (e.g., one or more chips or other IC components) can adjust the frequency of the voltage applied by voltage source 1304 until the measured voltage is half of the input voltage. An inductance calculation component 1314 (e.g., one or more chips or other IC components) can calculate the inductance 1306 as a function of the resistance 1308 and the adjusted frequency of the voltage source 1304. For example, the inductance 1306 may then be directly proportional to the resistance 1308 and inversely proportional to the frequency.

The exemplary force sensing circuitry 1350 shown in FIG. 15B may include a circuit 1352 that has at least a voltage source 1354, an inductance 1356, a capacitance 1358 (labeled R), and a resistance 1359. The inductance 1356 and the capacitance 1358 are coupled in parallel. The voltage source 1354, the parallel coupling of the inductance 1356 and the capacitance 1358, and the resistance 1359 are electrically connected to each other in series as indicated to complete the circuit 1352. The inductance 1356 is the inductance that is the subject of the force sensing (e.g., the (varying) inductance of an inductive element such as the exemplary inductive element 150 in FIG. 14). The capacitance 1358 may be a known capacitance. The resistance 1359 may be a known resistance. In operation, the voltage source 1354 may provide voltage to the circuit 1352 in form of AC. A voltage measurement component 1360 (e.g., one or more chips or other integrated circuit (IC) components), may measure voltage at the junction between the resistance 1359 and the parallel coupling of the inductance 1356 and the capacitance 1358. A frequency adjustment component 1362 (e.g., one or more chips or other IC components) can adjust the frequency of the voltage applied by voltage source 1354 until the measured voltage shows a maximum response, corresponding to the resonant point of the parallel coupling of the inductance 1356 and the capacitance 1358. An inductance calculation component 1364 (e.g., one or more chips or other IC components) can calculate the inductance 1356 as a function of the capacitance 1358 and the adjusted frequency of the voltage source 1354. For example, the inductance 1356 may then be inversely proportional to both the capacitance 1358 and the frequency.

FIG. 16 shows an example of a generic computer device 1400 and a generic mobile computer device 1450, which may be used with the techniques described here. Computing device 1400 is intended to represent various forms of digital computers, such as laptops, desktops, tablets, workstations, personal digital assistants, televisions, servers, blade servers, mainframes, and other appropriate computing devices. Computing device 1450 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. The processor 1402 can be a semiconductor-based processor. The memory 1404 can be a semiconductor-based memory. Each of the components 1402, 1404, 1406, 1408, 1410, and 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port, which may include various communication ports (e.g., USB, Bluetooth, Ethernet, wireless Ethernet) may be coupled to one or more input/output devices, such as any of the above-described trackpad architectures or assemblies, a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468, are interconnected using various buses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provided as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, or memory on processor 1452, that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, WiFi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smart phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and any of the above-described trackpad architectures or assemblies and/or a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, other steps may be provided, or steps may be eliminated, from the described flows, and other components may be added to, or removed from, the described systems. Accordingly, other embodiments are within the scope of the following claims.

1. A computer-implemented method for detecting a condition of a plurality of compliant members of a touchpad assembly installed in a computing device, comprising:
detecting, by a processor of the computing device, a current resistivity value of the touchpad assembly;
comparing, by the processor, the current resistivity value to a set resistivity value;
determining, by the processor, a difference between the current resistivity value and the set resistivity value; and
re-setting, by the processor, at least one calibration weight associated with the touchpad assembly in response to a determination that the difference between the current resistivity value and the set resistivity value is greater than a threshold difference value.

2. The computer-implemented method of claim 1, wherein
detecting the current resistivity value includes detecting the current resistivity value corresponding to a given input force at the touchpad assembly; and
comparing the current resistivity value to the set resistivity value includes comparing the current resistivity value corresponding to the given input force to the set resistivity value corresponding to the given input force.

3. The computer-implemented method of claim 2, wherein re-setting the at least one calibration weight includes re-setting a calibration weight associated with the touchpad assembly corresponding to the given input force.

4. The computer-implemented method of claim 1, wherein re-setting the at least one calibration weight includes:
receiving, by the processor from an external source, one or more updated calibration weights; and
re-setting, by the processor, the one or more calibration weights based on the received updated calibration weights.

5. The computer-implemented method of claim 1, wherein the detecting, the comparing, and the determining by the processor includes:
iteratively detecting the current resistivity value;
iteratively comparing the current resistivity value to the set resistivity value; and
iteratively determining the difference between the current resistivity value and the set resistivity value.

6. (canceled)

7. A system, comprising:
a touchpad assembly; and
a processor operably coupled to the touchpad assembly, the processor being configured to execute a method, the method including:
detecting a current resistivity value of the touchpad assembly corresponding to a given input force;
comparing the current resistivity value to a set resistivity value at the given input force;
determining a difference between the current resistivity value and the set resistivity value; and
re-setting at least one calibration weight associated with the touchpad assembly in response to a determination that the difference between the current resistivity value and the set resistivity value is greater than a threshold difference value

8. The system of claim 7, wherein re-setting the at least one calibration weight includes:
receiving one or more updated calibration weights from an external source; and
re-setting the one or more calibration weights based on the received updated calibration weights.

9. A computer-implemented method for detecting a condition of a plurality of compliant members of a touchpad assembly, comprising:
applying a plurality of stresses to the touchpad assembly, including:
applying a tensile stress to a touch input surface of the touchpad assembly; and
sequentially applying a plurality of shear stresses to the touch input surface of the touchpad assembly;
measuring a resistivity of the touchpad assembly; and
detecting the condition of the plurality of compliant members based on the resistivity.

10. The computer-implemented method of claim 9, wherein measuring the resistivity of the touchpad assembly includes measuring the resistivity of the touchpad assembly concurrently with applying the plurality of stresses to the touchpad assembly.

11. The computer-implemented method of claim 9, wherein detecting the condition of the plurality of compliant members includes:
comparing the measured resistivity of the touchpad assembly to a threshold resistivity value;
detecting that the measured resistivity is different from the threshold resistivity value; and
detecting a fault in one or more of the plurality of compliant members in response to the detection of the measured resistivity that is different from the threshold resistivity.

12. The computer-implemented method of claim 11, wherein
detecting that the measured resistivity is different from the threshold resistivity value includes detecting that the measured resistivity is different from the threshold resistivity value by a set amount; and
detecting the fault includes detecting the fault in one or more of the plurality of compliant members in response to the detection of the measured resistivity that is different from the threshold resistivity by the set amount.

13. The computer-implemented method of claim 12, wherein detecting that the measured resistivity is different from the threshold resistivity value by a set amount includes detecting that the measured resistivity is greater than the threshold resistivity value by the set amount.

14. The computer-implemented method of claim 12, wherein detecting that the measured resistivity is different from the threshold resistivity value by a set amount includes detecting that the measured resistivity is less than the threshold resistivity value by the set amount.

15. The computer-implemented method of claim 9, wherein sequentially applying the plurality of shear stresses to the touch input surface of the touchpad assembly includes:
applying a first shear stress in a first direction with respect to the touch input surface of the touchpad assembly; and
applying a second shear stress in a second direction with respect to the touch input surface of the touchpad assembly.

16. The computer-implemented method of claim 15, wherein sequentially applying the plurality of shear stresses to the touch input surface of the touchpad assembly also includes:
applying a third shear stress in a third direction with respect to the touch input surface of the touchpad assembly; and
applying a fourth shear stress in a fourth direction with respect to the touch input surface of the touchpad assembly.

17. The computer-implemented method of claim 16, wherein
applying the first shear stress includes applying the first shear stress in the first direction, at a first portion of the touch input surface of the touchpad assembly so as to apply the first shear stress to a first subset of the plurality of compliant members; and
applying the second shear stress includes applying the second shear stress in the second direction, at a second portion of the touch input surface of the touchpad assembly so as to apply the second shear stress to a second subset of the plurality of compliant members.

18. The computer-implemented method of claim 17, wherein
applying the third shear stress includes applying the third shear stress in the third direction, at a third portion of the touch input surface of the touchpad assembly so as to apply the third shear stress to a third subset of the plurality of compliant members; and
applying the fourth shear stress includes applying the fourth shear stress in the fourth direction, at a fourth portion of the touch input surface of the touchpad assembly so as to apply the fourth shear stress to a fourth subset of the plurality of compliant members.

19. The computer-implemented method of claim 18, wherein
the second direction is opposite the first direction; and
the third direction and the fourth direction are substantially orthogonal to the first direction and the second direction.

20. The computer-implemented method of claim 18, wherein
the first portion of the touch input surface is a first corner portion of the touch input surface;
the second portion of the touch input surface is a second corner portion of the touch input surface;
the third portion of the touch input surface is a third corner portion of the touch input surface; and
the fourth portion of the touch input surface is a fourth corner portion of the touch input surface.
